(19) United States
(12) Patent Application Publication
(10) Pub. No.: US 2024/0210961 A1
(43) Pub. Date: Jun. 27, 2024

(54) METHOD AND APPARATUS FOR CONTROLLING AIRCRAFT FOR FOLLOWING AND PHOTOGRAPHING, ELECTRONIC DEVICE, AND STORAGE MEDIUM

(71) Applicant: AUTEL ROBOTICS CO., LTD., Shenzhen (CN)

(72) Inventors: Guangxin CUI, Shenzhen (CN); Bin ZHANG, Shenzhen (CN)

(21) Appl. No.: 18/597,133

(22) Filed: Mar. 6, 2024

Related U.S. Application Data
(63) Continuation of application No. PCT/CN2022/117622, filed on Sep. 7, 2022.

(30) Foreign Application Priority Data
Sep. 7, 2021 (CN) 202111045441.X

(51) Int. Cl. G05D 1/689; G05D 1/243; G05D 109/20; G05D 111/10; H04N 7/18; H04N 23/61; H04N 23/63; H04N 23/667; H04N 23/695

(52) U.S. Cl. CPC G05D 1/689; G05D 1/243; H04N 7/183; H04N 23/61; H04N 23/631; H04N 23/667; H04N 23/695; G05D 2109/20; G05D 2111/10

(57) ABSTRACT

Embodiments of the present disclosure disclose a method and apparatus for controlling an aircraft for following and photographing, an electronic device, and a storage medium. The method includes: receiving a following instruction of a user, and controlling an aircraft to enter a following mode according to the following instruction; obtaining a currently captured picture of the aircraft, and displaying the currently captured picture to the user, so that the user selects a following target from the currently captured picture; controlling the aircraft to lock on the following target for following and photographing, and displaying a following orientation control to the user; and controlling, according to an operation of the user on the following orientation control, the aircraft to switch a following orientation.

### CROSS-REFERENCE TO RELATED APPLICATIONS

This application is a Continuation Application of International Application No.PCT/CN2022/117622, filed on Sep. 7, 2022, which claims priority to Chinese Patent Application No. 202111045441.X, entitled “METHOD AND APPARATUS FOR CONTROLLING AIRCRAFT FOR FOLLOWING AND PHOTOGRAPHING, ELECTRONIC DEVICE, AND STORAGE MEDIUM” and filed with the China National Intellectual Property Administration on Sep. 7, 2021, which is incorporated herein by reference in its entirety.

### BACKGROUND

Following photography, also known as following lens, refers to a photographing method that can adapt to the movement of a moving object and follow the movement of a photographed subject. With the advancement of science and technology, following photography technology is widely used in power inspection, remote sensing mapping, environmental monitoring, film and television photography, and live streaming. The existing following photography solutions mainly include two methods: following photography via real-time control of a remote control device and automatic following photography based on image information. The former requires a dedicated person to make frequent and professional adjustments to a following and photographing device according to the photographing situation. In comparison, the latter is easier to use and is increasingly favored by people, and can generally be achieved through an aircraft such as an unmanned aerial vehicle.

According to the current following photography solution, after a photographing target is determined, only a relatively fixed orientation relative to the photographing target can be maintained for following and photographing, and when a following orientation needs to be switched, a user needs to manually adjust the following orientation by using a remote control lever. In many scenarios, the time available for the user to adjust is very short, so the adjustment of the following orientation cannot be accurately completed in time, and the adjustment process is also very troublesome.

### SUMMARY

Embodiments of the present invention relate to the field of unmanned aerial vehicle control technologies, and in particular, to a method and apparatus for controlling an aircraft for following and photographing, an electronic device, and a storage medium.

Embodiments of the present disclosure provide a method and apparatus for controlling an aircraft for following and photographing, an electronic device, and a storage medium, to solve the problem of not being able to adjust the following orientation in time, thereby realizing simple, fast, and accurate switching of the following orientation.

In a first aspect, the embodiments of the present disclosure provide a method for controlling an aircraft for following and photographing. The method includes:
receiving a following instruction of a user, and controlling an aircraft to enter a following mode according to the following instruction;
obtaining a currently captured picture of the aircraft, and displaying the currently captured picture to the user, so that the user selects a following target from the currently captured picture;
controlling the aircraft to lock on the following target for following and photographing, and displaying a following orientation control to the user; and
controlling, according to an operation of the user on the following orientation control, the aircraft to switch a following orientation.

In a second aspect, the embodiments of the present disclosure further provide an apparatus for controlling an aircraft for following and photographing. The apparatus includes:
a following instruction receiving module, configured to receive a following instruction of a user, and control an aircraft to enter a following mode according to the following instruction;
a following target determining module, configured to obtain a currently captured picture of the aircraft, and display the currently captured picture to the user, so that the user selects a following target from the currently captured picture;
an orientation control display module, configured to control the aircraft to lock on the following target for following and photographing, and display a following orientation control to the user; and
a following orientation switching module, configured to control, according to an operation of the user on the following orientation control, the aircraft to switch a following orientation.

In a third aspect, the embodiments of the present disclosure further provide an electronic device. The electronic device includes:
one or more processors; and
a memory, configured to store one or more programs.

The one or more programs, when executed by the one or more processors, cause the one or more processors to implement the method for controlling an aircraft for following and photographing according to any embodiment of the present disclosure.

In a fourth aspect, the embodiments of the present disclosure further provide a computer-readable storage medium, having a computer program stored thereon. The program, when executed by a processor, implements the method for controlling an aircraft for following and photographing according to any embodiment of the present disclosure.

### BRIEF DESCRIPTION OF THE DRAWINGS

FIG. 1 is a flowchart of a method for controlling an aircraft for following and photographing according to embodiment 1 of the present disclosure.

FIG. 2 is a schematic structural diagram of an interactive interface provided after entering an application according to embodiment 1 of the present disclosure.

FIG. 3 is a schematic structural diagram of an interactive interface for displaying a guide video according to embodiment 1 of the present disclosure.

FIG. 4 is a schematic structural diagram of an interactive interface for displaying a followable object identifier according to embodiment 1 of the present disclosure.

FIG. 5 is a schematic structural diagram of an interactive interface for displaying a following orientation control according to embodiment 1 of the present disclosure.

FIG. 6 is a schematic structural diagram of an apparatus for controlling an aircraft for following and photographing according to embodiment 2 of the present disclosure.

FIG. 7 is a schematic structural diagram of an electronic device according to embodiment 3 of the present disclosure.

### DETAILED DESCRIPTION

The following further describes in detail the present disclosure with reference to the accompanying drawings and embodiments. It can be understood that the specific embodiments described herein are merely used to explain the present disclosure but are not intended to limit the present disclosure. In addition, it should be noted that, for the convenience of description, only the parts related to the present disclosure are shown in the accompanying drawings.

Before discussing exemplary embodiments in more detail, it should be mentioned that some exemplary embodiments are described as processes or methods depicted as flowcharts.

Although the flowcharts depict steps as sequential processing, many of the steps can be implemented in parallel, concurrently, or simultaneously. Furthermore, the order of the steps can be rearranged. The processing may be terminated when the operation is completed, but may also have additional steps not included in the accompanying drawings. The processing may correspond to methods, functions, procedures, subroutines, subroutines, and so on.

### Embodiment 1

FIG. 1 is a flowchart of a method for controlling an aircraft for following and photographing according to embodiment 1 of the present disclosure. This embodiment can be applied to situations where an aircraft is used to automatically follow and photograph a target object. The method can be executed by an apparatus for controlling an aircraft for following and photographing according to the embodiments of the present disclosure. The apparatus can be implemented by hardware and/or software, and can generally be integrated into an electronic device. The electronic device may be, but is not limited to, a smartphone, a tablet, and the like. As shown in FIG. 1, the method specifically includes the following steps.

S11: Receive a following instruction of a user, and control an aircraft to enter a following mode according to the following instruction.

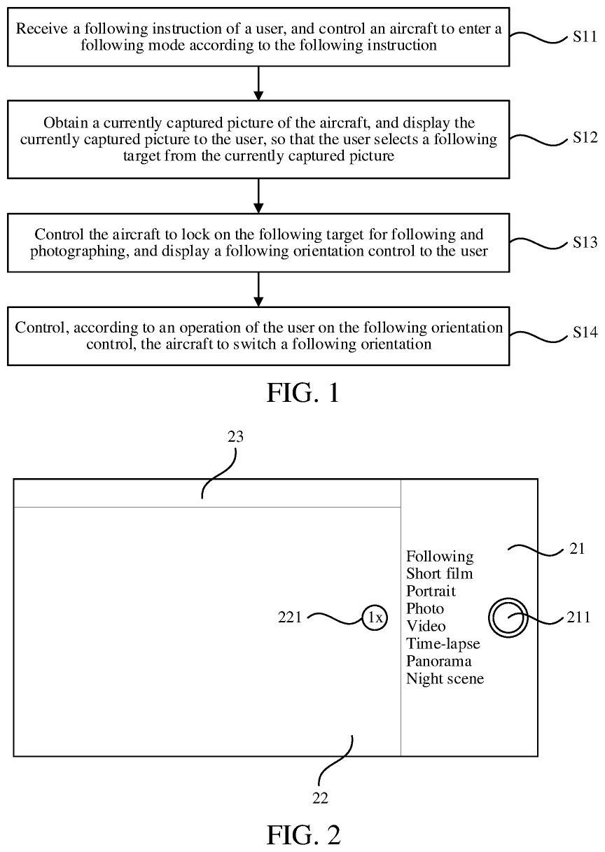

The aircraft may be any flying object made by humans that can fly off the ground, fly in space, and can be controlled by humans. Specifically, using the use of a mobile phone to control an aircraft as an example, after the mobile phone is connected to the aircraft through a remote control, the aircraft can be controlled through an application (APP) installed on the mobile phone. After entering the APP, the user can be provided with an interactive interface as shown in FIG. 2. The interactive interface includes a control interface 21, a captured picture display interface 22 and a status bar 23. The control interface 21 includes a variety of mode selection controls, such as following, short film, portrait, photo, video, time-lapse, panorama, and night scene, and further includes a photographing start key 211. The user can select a desired mode through a mode selection control, and can take photos or videos in a corresponding mode by pressing the photographing start key 211. Besides, the control interface 21 may further include controls such as a gallery, image parameter settings, and more functions, which can be used to open the gallery, set image parameters, and open more functional options, respectively. The captured picture display interface 22 is used for displaying a captured picture of the aircraft in real time, and may include an image scaling control 221. The user can adjust the size of the captured picture by tapping on the image zoom control 221. The status bar 23 can be used for displaying some common statuses of the mobile phone, such as signal strength, power, and picture aspect ratio. The status bar 23 may be transparent, that is, except for the content that needs to be displayed, the status bar not block the captured picture display interface 22 to expand the field of view of picture display. After entering the APP, the user may select a following mode control by swiping or tapping to generate a following instruction, or after selecting a following mode control, generate a following instruction when tapping on the photographing start key 211. After receiving the following instruction of the user, the aircraft can be controlled to enter a following mode according to the following instruction to execute subsequent steps. When the user selects the following mode control, the display style of the following mode control can be changed, for example, changing color, bolding, tilting or displacement, to prompt the user for the currently selected mode. In particular, when entering the APP, the mode can be selected to be the following mode by default.

Optionally, before controlling the aircraft to enter the following mode according to the following instruction, the method further includes: determining whether the aircraft has currently completed takeoff, and if not, prompting the user to take off first. Specifically, a judgment as to whether the aircraft has taken off can be made after entering the APP, or the judgment can be made when receiving the following instruction of the user. If the aircraft has not taken off, the user is prompted to control the aircraft to take off first, and then take pictures after taking off. Specifically, the user can be prompted with text at the upper middle position of the captured picture display interface 22. For example, the text may be “The aircraft has not taken off and cannot be followed for photographing” or the like.

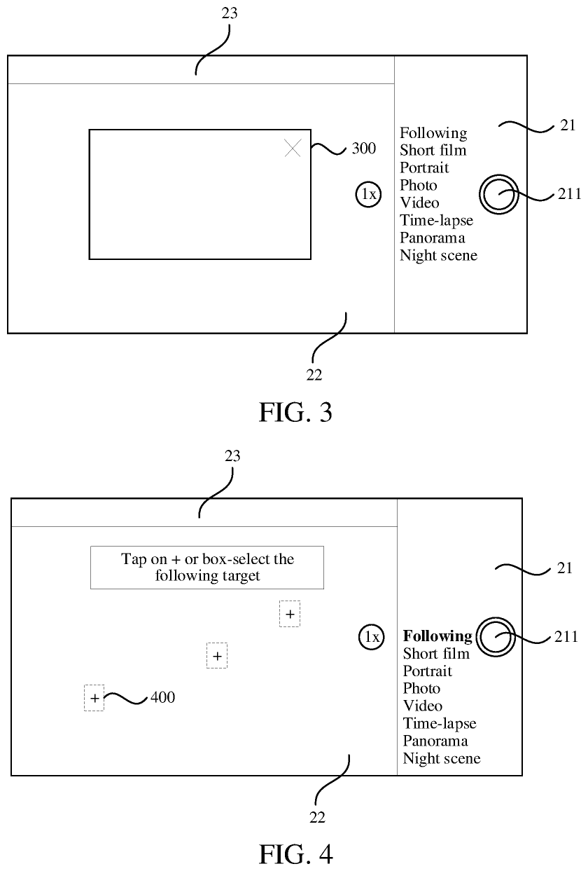

Optionally, after controlling the aircraft to enter the following mode according to the following instruction, the method further includes: displaying a following operation guide video and/or a photographing effect video to the user. Specifically, as shown in FIG. 3, after it is determined that the aircraft has entered the following mode, a following operation guide video and/or a photographing effect video can be displayed in a video box 300 at the center position of the captured picture display interface 22. Specifically, only the following operation guide video or the photographing effect video is displayed, or the following operation guide video and the photographing effect video are displayed successively. The content of the following operation guide video may include demonstrations of control methods in a following and photographing process. The content of the photographing effect video may include display of photographing effects obtained by executing various control methods and the like, to remind the user how to use a following function. The video box 300 may include a close key (“x” in FIG. 3) at the edge (e.g., the upper right corner). Therefore, the user can tap on the close key to close the video to enter a subsequent control process.

S12: Obtain a currently captured picture of the aircraft, and display the currently captured picture to the user, so that the user selects a following target from the currently captured picture.

Specifically, after entering the following mode, the aircraft can capture a picture in front of a camera in real time and transmit the picture to the mobile phone, so that the mobile phone can obtain the currently captured picture of the aircraft, and then display the currently captured picture through the captured picture display interface. By observing the currently captured picture, the user can determine a desired following target and select the following target by tapping or box selection. The following target may be a pedestrian, a vehicle, a boat, or the like.

Optionally, after obtaining the currently captured picture of the aircraft, the method further includes: automatically identifying and marking a followable object in the currently captured picture; and determining the followable object selected by the user as the following target. Specifically, after the currently captured picture of the aircraft is obtained, the followable object in the currently captured picture can be automatically identified. Specifically, an object can be preset, for example, to follow a pedestrian, all pedestrians in the currently captured picture can be automatically identified first, or to follow a variety of objects such as pedestrians or cars, the variety of objects such as all the pedestrians and cars in the currently captured picture can be automatically identified first. After being identified, as shown in FIG. 4, the followable object can be marked with a marking box 400 in the captured picture display interface 22, and can be indicated by using “+” in the marking box 400, so that the user can make a quick selection. Moreover, the user can be prompted with text at any position (such as the upper middle position) in the captured picture display interface 22 to make a selection, for example, “tap on + or box-select the following target”. Therefore, the user can tap on “+” or box-select one of the marking boxes 400 to determine the following target to be selected, and the mobile phone can determine and obtain the following target according to the selection of the user. In addition, as shown in FIG. 4, after the user selects the following mode, the following mode control can be aligned with the photographing start key 211, and the following mode control can be displayed in bold to prompt the user for the currently selected mode.

S13: Control the aircraft to lock on the following target for following and photographing, and display a following orientation control to the user.

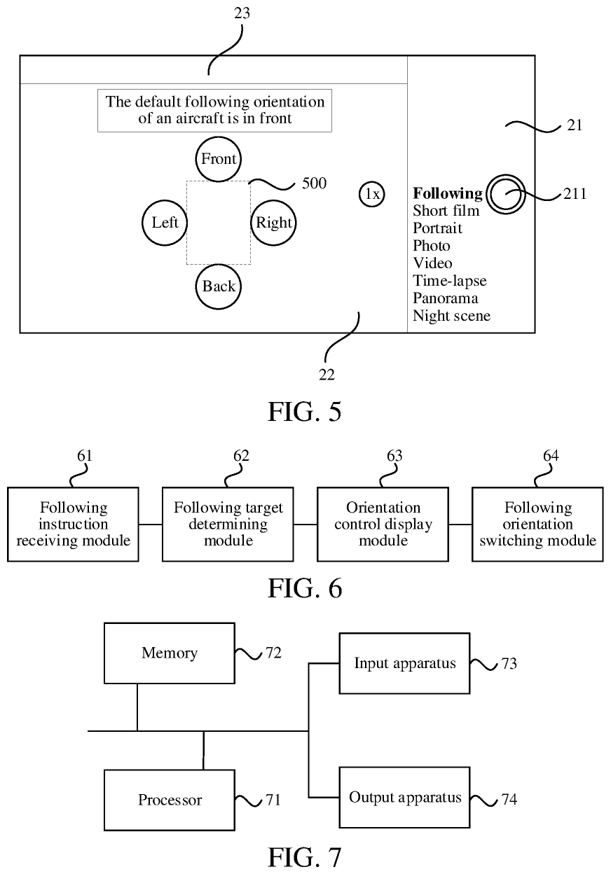

Specifically, after the following target is determined, the aircraft can be controlled to lock on the following target for following and photographing, that is, the aircraft can be controlled to move with the following target for photographing and recording a video. The aircraft can also be kept in the following mode to obtain a captured picture in real time and transmit the captured picture to the mobile phone for display. The user can press the photographing start key at a specified moment to start actual video recording. After the recording starts, the user can be prompted that photographing has started and the photographing progress, such as the current photographing duration, can be displayed in real time. After the aircraft is controlled to lock on the following target for following and photographing, as shown in FIG. 5, the following orientation control 500 can be displayed in the captured picture display interface 22, in which four orientations of front, back, left, and right are shown as an example. In the following and photographing, the following target can be kept in a box of the following orientation control 500 so that the user can observe the following target in time, and adjusts the following orientation according to the overall picture by using the following orientation control 500. The following orientation is the position relative to the following target, for example, in front, which means to keep in front of the following target for following and photographing.

Optionally, controlling the aircraft to lock on the following target for following and photographing includes: controlling the aircraft to follow and photograph the following target from a default following orientation, and prompting the user for the default following orientation. Specifically, the default following orientation may be in front, that is, after being controlled for following and photographing, the aircraft is kept in front of the following target for following and photographing without user selection or operation. Furthermore, as shown in FIG. 5, the user can be prompted with text in the upper middle position of the captured picture display interface 22 for the specific default following orientation. For example, the text may be “The default following orientation of the aircraft is in front”. Alternatively, the “front” key in the following orientation control 500 can be displayed as selected, for example, filled with a different color from other orientation keys, so that the user knows the current following orientation, thereby facilitating adjustment of the user.

Optionally, after obtaining the currently captured picture of the aircraft, and displaying the currently captured picture to the user, so that the user selects the following target from the currently captured picture, the method further includes: determining a current following orientation of the aircraft relative to the following target and displaying the current following orientation to the user, so that the user determines a desired target following orientation according to the current following orientation. Specifically, after the following target is determined, instead of adjusting the following orientation, the aircraft can be controlled to maintain the current following orientation for following and photographing. Furthermore, the current following orientation of the aircraft relative to the following target can be automatically determined, and can also be prompted to the user through text or by displaying the orientation key as selected, so that the user determines, according to the current following orientation, the target following orientation to be adjusted to, thereby reducing excessive judgment and selection processes of the user. Using the following target being a pedestrian as an example, the specific orientation judgment process can be achieved by adding Face ID and the framework of a human skeleton through deep learning, and the following orientation may be the position relative to a face direction. The orientation key is limited to the four types of “front, back, left, and right” in FIG. 5, and may further include more orientations, such as left oblique front, left oblique back, right oblique front, and right oblique back, to provide a more accurate orientation representation.

S14: Control, according to an operation of the user on the following orientation control, the aircraft to switch a following orientation.

Specifically, as shown in FIG. 5, the user can switch the following orientation by tapping on each orientation key in the following orientation control 500, for example, the current following orientation is in front. When the user taps on the “left” key, the aircraft can be controlled to switch the following orientation to the left. Optionally, after controlling, according to the operation of the user on the following orientation control, the aircraft to switch the following orientation, the method further includes: feeding back the switched following orientation to the user. That is, after being switched, the following orientation can be fed back to the user through text or by displaying the switched orientation key as selected, so that the user knows that switching has been completed currently. While using the following orientation control to switch the following orientation, adjustments can also be made through a conventional remote control lever to provide the user with diversified ways to meet various needs of the user. After completing the recording of a following video, the user can end the recording by tapping on the photographing start key again, and the recorded following video can be saved to an album of the mobile phone.

Alternatively or additionally, after the obtaining a currently captured picture of the aircraft, the method further includes:
automatically identifying and marking a followable object in the currently captured picture; and
determining the followable object selected by the user as the following target.

Alternatively or additionally, after the obtaining a currently captured picture of the aircraft, and displaying the currently captured picture to the user, so that the user selects a following target from the currently captured picture, the method further includes:
determining a current following orientation of the aircraft relative to the following target and displaying the current following orientation to the user, so that the user determines a desired target following orientation according to the current following orientation.

Alternatively or additionally, the controlling the aircraft to lock on the following target for following and photographing includes:
controlling the aircraft to follow and photograph the following target from a default following orientation, and prompting the user for the default following orientation.

Alternatively or additionally, after the controlling, according to an operation of the user on the following orientation control, the aircraft to switch a following orientation, the method further includes:
feeding back the switched following orientation to the user.

Alternatively or additionally, before the controlling an aircraft to enter a following mode according to the following instruction, the method further includes:
determining whether the aircraft has currently completed takeoff, and if not, prompting the user to take off first.

Alternatively or additionally, after the controlling an aircraft to enter a following mode according to the following instruction, the method further includes:
displaying a following operation guide video and/or a photographing effect video to the user.

The technical solution provided by the embodiments of the present disclosure includes: first, receiving a following instruction of a user, and controlling an aircraft to enter a following mode according to the following instruction; and then, obtaining a currently captured picture of the aircraft, and displaying the currently captured picture to the user, so that the user selects a following target from the currently captured picture. After the following target is determined, the aircraft can be controlled to lock on the following target for following and photographing, and a following orientation control can be displayed to the user, so that according to an operation of the user on the following orientation control, the aircraft can be controlled to switch a following orientation. By providing the user with the following orientation control, the user can adjust the following orientation of the aircraft through the following orientation control. Therefore, the problem of untimeliness in a conventional following and photographing method due to the fact that a user needs to make manual adjustments through a remote control is solved, so that the following orientation can be switched easily, quickly, and accurately, thereby providing great convenience for users.

FIG. 6 is a schematic structural diagram of an apparatus for controlling an aircraft for following and photographing according to embodiment of the present disclosure. The apparatus can be implemented by hardware and/or software, can generally be integrated into an electronic device and configured to execute the method for controlling an aircraft for following and photographing according to any embodiment of the present disclosure. As shown in FIG. 6, the apparatus includes:

a following instruction receiving module 61, configured to receive a following instruction of a user, and control an aircraft to enter a following mode according to the following instruction;
a following target determining module 62, configured to obtain a currently captured picture of the aircraft, and display the currently captured picture to the user, so that the user selects a following target from the currently captured picture;
an orientation control display module 63, configured to control the aircraft to lock on the following target for following and photographing, and display a following orientation control to the user; and
a following orientation switching module 64, configured to control, according to an operation of the user on the following orientation control, the aircraft to switch a following orientation.

The technical solution provided by the embodiments of the present disclosure includes: first, receiving a following instruction of a user, and controlling an aircraft to enter a following mode according to the following instruction; and then, obtaining a currently captured picture of the aircraft, and displaying the currently captured picture to the user, so that the user selects a following target from the currently captured picture. After the following target is determined, the aircraft can be controlled to lock on the following target for following and photographing, and a following orientation control can be displayed to the user, so that according to an operation of the user on the following orientation control, the aircraft can be controlled to switch a following orientation. By providing the user with the following orientation control, the user can adjust the following orientation of the aircraft through the following orientation control. Therefore, the problem of untimeliness in a conventional following and photographing method due to the fact that a user needs to make manual adjustments through a remote control is solved, so that the following orientation can be switched easily, quickly, and accurately, thereby providing great convenience for users.

Based on the described technical solution, optionally, the apparatus for controlling an aircraft for following and photographing further includes:
a followable object identification module, configured to automatically identify and mark a followable object in the currently captured picture after obtaining the currently captured picture of the aircraft; and
a user selection module, configured to determine the followable object selected by the user as the following target.

Based on the described technical solution, optionally, the apparatus for controlling an aircraft for following and photographing further includes:
a current following orientation determining module, configured to, after obtaining the currently captured picture of the aircraft, and displaying the currently captured picture to the user, so that the user selects the following target from the currently captured picture, determine a current following orientation of the aircraft relative to the following target and display the current following orientation to the user, so that the user determines a desired target following orientation according to the current following orientation.

Based on the described technical solution, optionally, the orientation control display module 63 includes:
a default orientation following unit, configured to control the aircraft to follow and photograph the following target from a default following orientation, and prompt the user for the default following orientation.

Based on the described technical solution, optionally, the apparatus for controlling an aircraft for following and photographing further includes:
a following orientation switching feedback module, configured to, after controlling, according to the operation of the user on the following orientation control, the aircraft to switch the following orientation, feed back the switched following orientation to the user.

Based on the described technical solution, optionally, the apparatus for controlling an aircraft for following and photographing further includes:
a takeoff judgment module, configured to, before controlling the aircraft to enter the following mode according to the following instruction, determine whether the aircraft has currently completed takeoff, and if not, prompt the user to take off first.

Based on the described technical solution, optionally, the apparatus for controlling an aircraft for following and photographing further includes:
a video display module, configured to, after controlling the aircraft to enter the following mode according to the following instruction, display a following operation guide video and/or a photographing effect video to the user.

The apparatus for controlling an aircraft for following and photographing provided in the embodiments of the present disclosure can execute the method for controlling an aircraft for following and photographing according to any embodiment of the present disclosure, and specifically execute functional modules and beneficial effects corresponding to the method.

It is worth noting that in the foregoing embodiments of the apparatus for controlling an aircraft for following and photographing, the units and modules included are only divided according to functional logic, but are not limited to the described division, as long as the corresponding functions can be achieved. In addition, the specific names of the functional units are only for the convenience of distinguishing between each other and are not used to limit the scope of protection of the present disclosure.

FIG. 7 is a schematic structural diagram of an electronic device according to embodiment of the present disclosure, and shows a block diagram of an exemplary electronic device suitable for implementing implementations of the present disclosure. The electronic device displayed in FIG. 7 is merely an example and is not intended to suggest any limitation as to the functions and the scopes of use of embodiments of the present disclosure. As shown in FIG. 7, the electronic device includes a processor 71, a memory 72, an input apparatus 73 and an output apparatus 74. The electronic device may include one or more processors 71. In FIG. 7, one processor 71 is used as an example. The processor 71, the memory 72, the input apparatus 73 and the output apparatus 74 in the electronic device may be connected through a bus or other means. In FIG. 7, connection through bus is taken as an example.

As a computer-readable storage medium, the memory 72 may be configured to store software programs, computer-executable programs and modules, such as program instructions/modules corresponding to the method for controlling an aircraft for following and photographing in the embodiments of the present disclosure (such as a following instruction receiving module 61, a following target determining module 62, an orientation control display module 63 and a following orientation switching module 64 in an apparatus for controlling an aircraft for following and photographing). The processor 71 runs the software programs, instructions and modules stored in the memory 72, to execute various functional applications and data processing of the electronic device, in other words, to implement the method for controlling an aircraft for following and photographing.

The memory 72 may mainly include a program storage area and a data storage area. The program storage area may store an operating system and an application that is required by at least one function. The data storage area may store data created based on use of the electronic device. In addition, the memory 72 may include a high-speed random access memory, and may also include a non-volatile memory, for example, at least one magnetic disk storage device, a flash memory device, or another non-volatile solid-state storage device. In some embodiments, the memory 72 may further include memories remotely disposed relative to the processor 71, and the remote memories may be connected to the electronic device through a network. Examples of the network include, but are not limited to, the Internet, an intranet, a local area network, a mobile communication network, and a combination thereof.

The input apparatus 73 may be configured to receive a following instruction of a user and an operation thereof on a following orientation control, and to generate key signal input related to user settings and function control of the electronic device, and the like. The output apparatus 74 may include a display screen and other devices, and may be configured to provide a human-computer interaction interface to the user, so as to display a captured picture, guidance content, and the like to the user.

Embodiment of the present disclosure further provides a storage medium containing computer-executable instructions. The computer-executable instructions, when executed by a computer processor, are used for executing a method for controlling an aircraft for following and photographing. The method includes:
receiving a following instruction of a user, and controlling an aircraft to enter a following mode according to the following instruction;
obtaining a currently captured picture of the aircraft, and displaying the currently captured picture to the user, so that the user selects a following target from the currently captured picture;
controlling the aircraft to lock on the following target for following and photographing, and displaying a following orientation control to the user; and
controlling, according to an operation of the user on the following orientation control, the aircraft to switch a following orientation.

The storage medium may be any of various types of memory devices or storage devices. The term “storage medium” is intended to include: an installation medium, such as CD-ROM, a floppy disk or a magnetic tape unit; a computer system memory or a random access memory, such as DRAM, DDR RAM, SRAM, EDO RAM, or Rambus RAM; a non-volatile memory, such as a flash memory, or a magnetic medium (such as a hard disk or a photomemory); and a register or other similar types of memory elements, or the like. The storage medium may also include other types of memories or combinations thereof. In addition, the storage medium may be located in the computer system in which a program is executed, or may be located in a different second computer system. The second computer system is connected to the computer system through a network (such as the Internet). The second computer system may provide program instructions to the computer for execution. The term “storage medium” may include two or more storage media that may reside in different locations (e.g., in different computer systems connected through a network). The storage medium may store program instructions (e.g., specifically embodied as a computer program) executable by one or more processors.

Certainly, the embodiments of the present disclosure provide a storage medium containing computer-executable instructions. The computer-executable instructions are not limited to operations of the method as stated above, and may also execute related operations in the method for controlling an aircraft for following and photographing provided by any embodiment of the present disclosure.

The computer-readable signal medium may include a data signal being in a baseband or transmitted as a part of a carrier, which carries computer-readable program code. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in conjunction with an instruction execution system, an apparatus, or a device.

The program code included in the computer-readable medium may be transmitted by using any suitable medium, including but not limited to, a wireless medium, a wire, a cable, RF or the like, or any other suitable combination thereof.

The embodiments of the present disclosure provide a method for controlling an aircraft for following and photographing, including: first, receiving a following instruction of a user, and controlling an aircraft to enter a following mode according to the following instruction; and then, obtaining a currently captured picture of the aircraft, and displaying the currently captured picture to the user, so that the user selects a following target from the currently captured picture. After the following target is determined, the aircraft can be controlled to lock on the following target for following and photographing, and a following orientation control can be displayed to the user, so that according to an operation of the user on the following orientation control, the aircraft can be controlled to switch a following orientation. According to the method for controlling an aircraft for following and photographing provided in the embodiments of the present disclosure, by providing the user with the following orientation control, the user can adjust the following orientation of the aircraft through the following orientation control. Therefore, the problem of untimeliness in a conventional following and photographing method due to the fact that a user needs to make manual adjustments through a remote control is solved, so that the following orientation can be switched easily, quickly, and accurately, thereby providing great convenience for users.

According to the descriptions in the foregoing implementations, a person skilled in the art may clearly learn that the present disclosure may be implemented by relying on software and necessary general hardware, and certainly, may also be implemented through hardware. However, in many cases, the former is a better implementation. Based on such an understanding, the technical solutions of the present disclosure essentially, or the part contributing to the prior art may be implemented in the form of a software product. The computer software product may be stored in a computer-readable storage medium, such as a floppy disk, a read-only memory (ROM), a random access memory (RAM), a flash, a hard disk, an optical disc, or the like of a computer, and include several instructions for instructing an electronic device (which may be a personal computer, a server, a network device, or the like) to perform the method described in the embodiments of the present disclosure.

Note that the above are merely preferred embodiments of the present disclosure and the technical principles used. A person skilled in the art may understand that the present disclosure is not limited to the specific embodiments described herein. Various obvious changes, readjustments and substitutions can be made by a person skilled in the art without departing from the scope of protection of the present disclosure. Therefore, although the present disclosure has been described in detail through the foregoing embodiments, the present disclosure is not limited to the forgoing embodiments, and may also include more other equivalent embodiments without departing from the concept of the present disclosure. Moreover, the scope of the present disclosure is determined by the appended claims.

What is claimed is:

1. A method for controlling an aircraft for following and photographing, comprising:
receiving a following instruction of a user, and controlling the aircraft to enter a following mode according to the following instruction;
obtaining a currently captured picture of the aircraft, and displaying the currently captured picture to the user, so that the user selects a following target from the currently captured picture;
controlling the aircraft to lock on the following target for following and photographing, and displaying a following orientation control to the user; and
controlling, according to an operation of the user on the following orientation control, the aircraft to switch a following orientation.

2. The method for controlling the aircraft for following and photographing according to claim 1, wherein after the obtaining the currently captured picture of the aircraft, the method further comprises:
automatically identifying and marking a followable object in the currently captured picture; and
determining the followable object selected by the user as the following target.

3. The method for controlling the aircraft for following and photographing according to claim 1, wherein after the obtaining the currently captured picture of the aircraft, and displaying the currently captured picture to the user, so that the user selects a following target from the currently captured picture, the method further comprises:
determining a current following orientation of the aircraft relative to the following target and displaying the current following orientation to the user, so that the user determines a desired target following orientation according to the current following orientation.

4. The method for controlling the aircraft for following and photographing according to claim 1, wherein the controlling the aircraft to lock on the following target for following and photographing comprises:
controlling the aircraft to follow and photograph the following target from a default following orientation, and prompting the user for the default following orientation.

5. The method for controlling the aircraft for following and photographing according to claim 1, wherein after the controlling, according to an operation of the user on the following orientation control, the aircraft to switch the following orientation, the method further comprises:
feeding back the switched following orientation to the user.

6. The method for controlling the aircraft for following and photographing according to claim 1, wherein before the controlling the aircraft to enter the following mode according to the following instruction, the method further comprises:
determining whether the aircraft has currently completed takeoff, and in response to the aircraft didn't take off, prompting the user to take off first.

7. The method for controlling the aircraft for following and photographing according to claim 1, wherein after the controlling the aircraft to enter the following mode according to the following instruction, the method further comprises:
displaying a following operation guide video to the user.

8. The method for controlling the aircraft for following and photographing according to claim 1, wherein after the controlling the aircraft to enter the following mode according to the following instruction, the method further comprises:
displaying a photographing effect video to the user.

9. An apparatus for controlling an aircraft for following and photographing, comprising:
a following instruction receiving unit, configured to receive a following instruction of a user, and control the aircraft to enter a following mode according to the following instruction;
a following target determining unit, configured to obtain a currently captured picture of the aircraft, and display the currently captured picture to the user, so that the user selects a following target from the currently captured picture;
an orientation control display unit, configured to control the aircraft to lock on the following target for following and photographing, and display a following orientation control to the user; and
a following orientation switching unit, configured to control, according to an operation of the user on the following orientation control, the aircraft to switch a following orientation.

10. An apparatus for controlling the aircraft for following and photographing according to claim 9, wherein after the obtain the currently captured picture of the aircraft, further comprise:
automatically identify and mark a followable object in the currently captured picture; and
determine the followable object selected by the user as the following target.

11. An apparatus for controlling the aircraft for following and photographing according to claim 9, wherein after the obtain the currently captured picture of the aircraft, and display the currently captured picture to the user, so that the user selects a following target from the currently captured picture, further comprises:
determine a current following orientation of the aircraft relative to the following target and display the current following orientation to the user, so that the user determines a desired target following orientation according to the current following orientation.

12. An apparatus for controlling the aircraft for following and photographing according to claim 9, wherein the control the aircraft to lock on the following target for following and photographing comprises:
control the aircraft to follow and photograph the following target from a default following orientation, and prompting the user for the default following orientation.

13. An apparatus for controlling the aircraft for following and photographing according to claim 9, wherein after the control, according to an operation of the user on the following orientation control, the aircraft to switch the following orientation, further comprises:
feed back the switched following orientation to the user.

14. An apparatus for controlling the aircraft for following and photographing according to claim 9, wherein before the control the aircraft to enter the following mode according to the following instruction, further comprises:
determine whether the aircraft has currently completed takeoff, and in response to the aircraft didn't take off, prompting the user to take off first.

15. An apparatus for controlling the aircraft for following and photographing according to claim 9, wherein after the control the aircraft to enter the following mode according to the following instruction, the method further comprises:
displaying a following operation guide video to the user.

16. An apparatus for controlling the aircraft for following and photographing according to claim 9, wherein after the control the aircraft to enter the following mode according to the following instruction, the method further comprises:
displaying a photographing effect video to the user.

17. An electronic device, comprising:
one or more processors; and
a memory, configured to store one or more programs, wherein
the one or more programs, when executed by the a processor, cause the processor to perform the method for controlling an aircraft for following and photographing, comprising:
receiving a following instruction of a user, and controlling the aircraft to enter a following mode according to the following instruction;
obtaining a currently captured picture of the aircraft, and displaying the currently captured picture to the user, so that the user selects a following target from the currently captured picture;
controlling the aircraft to lock on the following target for following and photographing, and displaying a following orientation control to the user; and
controlling, according to an operation of the user on the following orientation control, the aircraft to switch a following orientation.

18. An electronic device according to claim 17, comprising:
wherein after the obtaining the currently captured picture of the aircraft, the method further comprises:
automatically identifying and marking a followable object in the currently captured picture; and
determining the followable object selected by the user as the following target.

19. An electronic device according to claim 17, wherein after the obtaining the currently captured picture of the aircraft, and displaying the currently captured picture to the user, so that the user selects a following target from the currently captured picture, the method further comprises:
determining a current following orientation of the aircraft relative to the following target and displaying the current following orientation to the user, so that the user determines a desired target following orientation according to the current following orientation.

20. An electronic device according to claim 17, wherein the controlling the aircraft to lock on the following target for following and photographing comprises:
controlling the aircraft to follow and photograph the following target from a default following orientation, and prompting the user for the default following orientation.
